(19) United States
(12) Patent Application Publication
(10) Pub. No.: US 2004/0208196 A1
(43) Pub. Date: Oct. 21, 2004

(54) Data transfer method and system

(75) Inventor: Hiroaki Kuninobu, Tokyo (JP)

Correspondence Address: Norman P. Soloway, Esq., HAYES SOLOWAY P.C., 130 W. Cushing Street, Tucson, AZ, 85701, US

(73) Assignee: NEC Corporation

(21) Appl. No.: 10/825,141

(22) Filed: Apr. 15, 2004

(30) Foreign Application Priority Data
Apr. 16, 2003 (JP) 2003-110955

(51) Int. Cl. H04J 3/16

(52) U.S. Cl. 370/465

(57) ABSTRACT

A data transfer system allowing transmission of control information independently of communication protocols is disclosed. A data transmission equipment working in a predetermined communication protocol receives a transmission signal including control information from upstream. The control information is forwarded to a transmitting section without controlling the control information according to the predetermined communication protocol. The transmitting section transmits a transmission signal including the control information to downstream.

### BACKGROUND OF THE INVENTION

1. Field of the Invention

The present invention relates to techniques of transferring control information from a control terminal to a target data transmission equipment through a data transmission network.

2. Description of the Related Art

With the recent increase in data transmission capacity, SONET (Synchronous Optical NETwork) or SDH (Synchronous Digital Hierarchy) has been employed as a basic transmission scheme for fiber-optic communication systems.

Taking the terminology of SDH, D1-D3 bytes are defined in Regenerator Section Overhead (RSOH) and D4-D12 bytes are defined in Multiplex Section Overhead (MSOH). These provide data communication channels (DCCs) to transfer control packets (if necessary, see ITU-T G.707 (March, 2000; 9 Overhead bytes description) and G.783 (April, 1997; Appendix VI Data Communication Channel (DCC)).

In order to transfer a control packet from the control terminal to target optical transmission equipment, a routing function is needed. As well known, the routing function can be realized by different protocols, for example, the TCP/IP protocol stack and the OSI protocol stack. In the case where the control terminal and optical transmission equipments all work based on the same routing protocol, it is possible for the control terminal to control each optical transmission equipment. However, in the case where network elements working in a different routing protocol exist between the control terminal and a target optical transmission equipment, the control packet cannot reach the target optical transmission equipment as described hereinafter.

As shown in FIG. 1, it is assumed that a control terminal 1 and optical transmission equipments 2 and 3 work in the same communication (routable) protocol A and a control terminal 4 and optical transmission equipments 5 and 6 work in a different communication (routable) protocol B, wherein the optical transmission equipments 5 and 6 are connected through the optical transmission equipments 2 and 3. In this network system, when the control terminal 4 sends a control packet (B) to the target optical transmission equipment 6 through the optical transmission equipment 5, the optical transmission equipment 2 receives the control packet (B) conformable to the different communication protocol B. Accordingly, the optical transmission equipment 2 cannot provide routing processing to the control packet (B).

Japanese Patent Application Unexamined Publication No. P2002-171274A discloses a method for transferring data between networks working in different protocols. For example, data of a first data frame conformable to a first communication (routable) protocol is combined with a header for a second communication (routable) protocol to produce a second data frame, allowing the second data frame to be transferred in the second network.

However, such a conversion between the first and second data frames is effective only in a combination of the first and second protocols, not working in a third protocol different from the first and second protocols.

### SUMMARY OF THE INVENTION

An object of the present invention is to provide data transfer method and system allowing transmission of control information through a network including transmission equipments working in different communication protocols, independently of communication protocols.

According to the present invention, a data transmission equipment working in a predetermined communication protocol includes: a receiving section for receiving a transmission signal including control information from upstream; a transmitting section for transmitting a transmission signal including control information to downstream; and a forwarding section for forwarding control information included in a received transmission signal to the transmitting section without controlling the control information according to the predetermined communication protocol.

The forwarding section may include: a data extractor for extracting the control information from the received transmission signal; and a data inserter for inserting the extracted control information into a predetermined one of a first location and a second location of the transmission signal to be transmitted.

In an embodiment, the first location is data communication channel (DCC) bytes of the transmission signal and the second location is DCC transmit bytes that are previously determined in the transmission signal.

The data transmission equipment may be set to one of the following configurations:

1) the data extractor extracts the control information from the first location of the received transmission signal, and the data inserter inserts the extracted control information into the second location;

2) the data extractor extracts the control information from the second location of the received transmission signal, and the data inserter inserts the extracted control information into the second location; and

3) the data extractor extracts the control information from the second location of the received transmission signal, and the data inserter inserts the extracted control information into the first location.

According to another aspect of the present invention, in a data transfer system for transferring control information from a control terminal to a target through a data transmission network including at least one data transmission equipment working in a predetermined communication protocol, a data transfer method at each of said at least one data transmission equipment, includes: a) receiving a transmission signal including control information at a receiving section from upstream; b) forwarding control information included in a received transmission signal to a transmitting section without controlling the control information according to the predetermined communication protocol; and c) transmitting a transmission signal including the control information from the transmitting section to downstream.

As described above, according to the present invention, the data transmission equipment can transfer the control information without control by the predetermined communication protocol. Accordingly, the control information is transferred from the control terminal to a targeted data transmission equipment through the data transmission network. Since the data transmission equipment do not provide control by the predetermined communication protocol to the control information, control information for any communication protocol can be transferred.

Further, in the case of a network composed of a plurality of data transmission equipments working in the same communication protocol, data transmission equipments according to the present invention can transfer control information without routing processing, resulting in the reduced number of hops from the control terminal to a targeted equipment.

### BRIEF DESCRIPTION OF THE DRAWINGS

FIG. 1 is a block diagram showing a communication network employing a conventional data transfer system;

FIG. 2 is a block diagram showing a Communication network employing a data transfer system according to a first embodiment of the present invention;

FIG. 3 is a diagram showing allocation of Section Overhead bytes in a SDH frame so as to explain data communication bytes D1-D12;

FIG. 4 is a diagram showing allocation of Section Overhead bytes in a SDH frame so as to explain data communication transmit bytes;

FIG. 5 is a block diagram showing an overhead processing section of optical transmission equipment according to the first embodiment of the present invention;

FIG. 6 is a diagram showing an example of an optical transmission network employing the data transfer system according to the first embodiment of the present invention;

FIG. 7 is a diagram showing an example of cross-connect control information for each optical transmission equipment according to the first embodiment;

FIG. 8 is a diagram showing an example of data communication byte select information for each optical transmission equipment according to the first embodiment;

FIG. 9A is a flowchart showing an operation of optical transmission equipment OTE2 according to the first embodiment;

FIG. 9B is a block diagram showing a schematic structure of the optical transmission equipment OTE2 for explaining its cross-connect operation;

FIG. 10A is a flowchart showing an operation of optical transmission equipment OTE3 according to the first embodiment;

FIG. 10B is a block diagram showing a schematic structure of the optical transmission equipment OTE3 for explaining its cross-connect operation;

FIG. 11A is a flowchart showing an operation of optical transmission equipment OTE4 according to the first embodiment;

FIG. 11B is a block diagram showing a schematic structure of the optical transmission equipment OTE4 for explaining its cross-connect operation; and

FIG. 12 is a block diagram showing a communication network employing a data transfer system according to a second embodiment of the present invention.

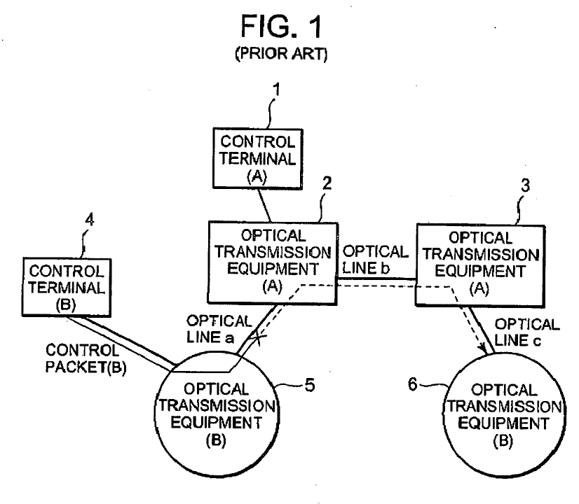

### DESCRIPTION OF THE PREFERRED EMBODIMENTS

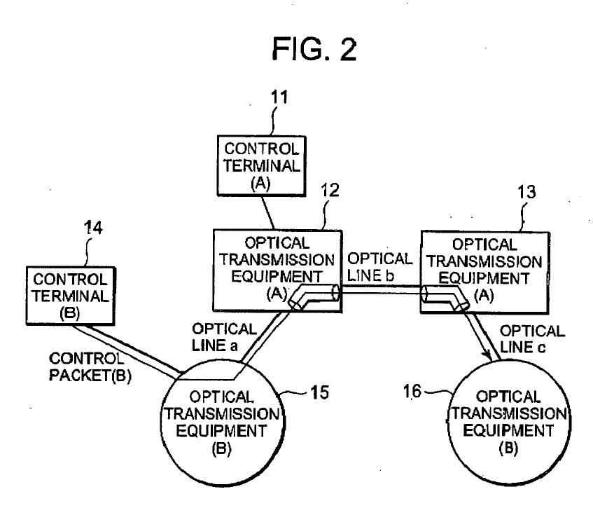

As shown in FIG. 2, for the sake of simplicity, it is assumed that a network is composed of a control terminal 11 and optical transmission equipments 12 and 13 working in the same communication (routable) protocol A, and a control terminal 14 and optical transmission equipments 15 and 16 working in a different communication (routable) protocol B. Accordingly, the optical transmission equipments 12 and 13 are allowed to provide routing processing to control packet (A) based on the communication protocol A. The optical transmission equipments 15 and 16 are allowed to provide routing processing to control packet (B) based on the communication protocol B.

In this example, the optical transmission equipment 15 is connected to the optical transmission equipment 12 through an optical line a, the optical transmission equipments 15 and 13 are connected through an optical line b, and the optical transmission equipment 13 is connected to the optical transmission equipment 16 through an optical line c.

According to the present invention, the optical transmission equipments 12 and 13 can provide routing processing to a control packet (B) without protocol processing. The details will be described later. Therefore, when the control terminal 14 sends a control packet (B) to the target optical transmission equipment 16 through the optical transmission equipment 15, the optical transmission equipment 12 receives the control packet (B) from the optical transmission equipment 15 and transmits it to the optical transmission equipment 13 through the optical line b. When having received the control packet (B) from the optical transmission equipment 12, the optical transmission equipment 13 transmits it to the optical transmission equipments 16 through the optical line c.

Taking the SDH system as an example, a data transfer system according to a first embodiment of the present invention will be described with reference to figures.

### 1. DCC Transmit Bytes

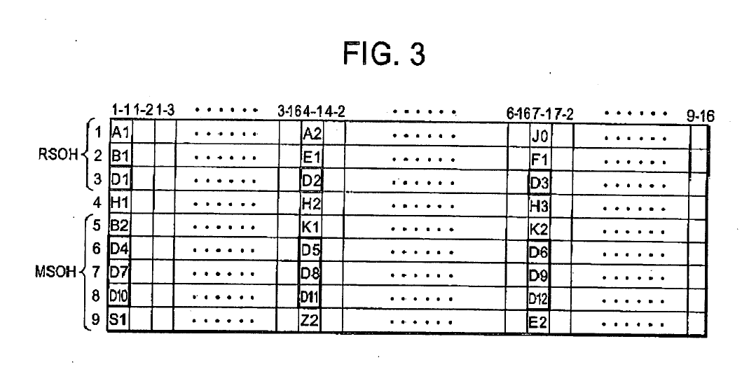

As shown in FIG. 3, D1-D3 bytes of RSOH and D4-D12 of MSOH are defined as Data Communication Channels (DCCs) in the section overhead of a SDH frame. Hereinafter, D1-D3 bytes or D4-D12 bytes are referred to as DCC bytes.

According to the present invention, not-yet-defined or reserved bytes used for control information transmission are referred to as DCC transmit bytes.

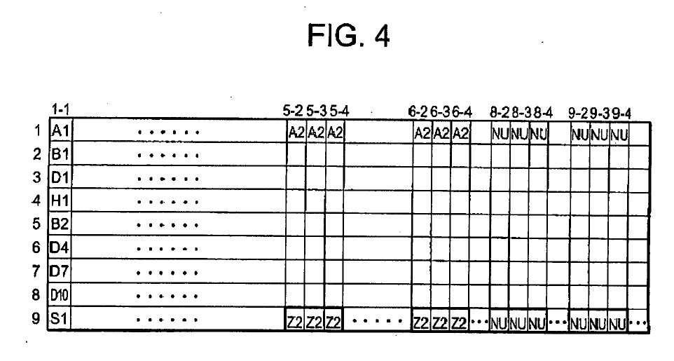

As shown in FIG. 4, Z2 bytes of columns 5-2, 5-3 and 5-4 in the 9th line are used as DCC transmit bytes corresponding to DCC (D1-D3) bytes. Z2 bytes of columns 6-2, 6-3 and 6-4 in the 9th line, NU bytes of columns 8-2, 8-3 and 8-4 in the 9th line, and NO bytes of columns 9-2, 9-3 and 9-4 in the 9th line are used as DCC transmit bytes corresponding to DC:C (D4-D12) bytes.

The DCC transmit bytes can be assigned to any combination of bytes that are not used for other functions. Therefore, the DCC transmit bytes are not restricted to the SDH frame as shown in FIG. 4. Similarly, DCC transmit bytes may be applied to the section overhead of another level SDH frame.

### 2. Optical Transmission Equipment

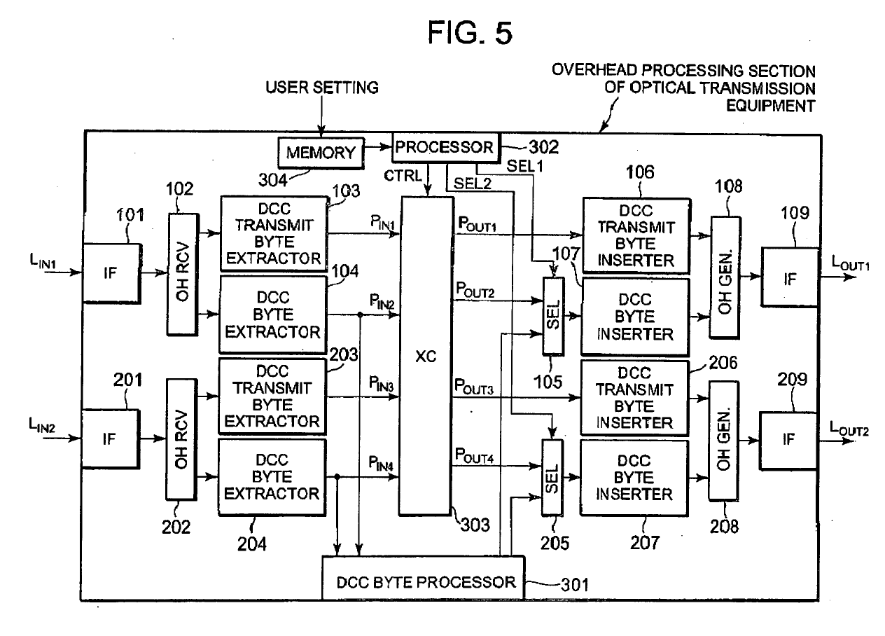

Referring to FIG. 5, optical transmission equipment according to the first embodiment of the present invention, which may be the optical transmission equipment 12 or 13 shown in FIG. 2, is connected to two optical input lines L_{IN1} and L_{IN2} and two optical output lines L_{OUT1} and L_{OUT2}.

In FIG. 5, for the sake of simplicity, the overhead processing section of the optical transmission equipment is mainly shown and the payload forwarding section is omitted.

The optical transmission equipment is provided with optical interface sections 101 and 201 each connected to the optical input lines L_{IN1} and L_{IN2} and optical interface sections 109 and 209 each connected to the optical output lines L_{OUT1} and L_{OUT2}.

The optical interface section 101 receives an optical transmission signal through the optical input line L_{IN1} and outputs a received signal to an overhead receiver (OH RCV) 102 The overhead receiver 102 extracts RSOH and MSOH front the received signal and outputs the RSOH and MSOH to both a DCC transmit byte extractor 103 and a DCC byte extractor 104. The DCC transmit byte extractor 103 extracts DCC transmit data from the DCC transmit bytes of the RSOH and MSOH to output it to an input port P_{IN1} of a cross connect 303. The DCC byte extractor 104 extracts DCC data from the DCC bytes of the RSOH and MSOH to output it to an input port P_{IN2} of the cross connect 303 and a DCC byte processor 301.

Similarly, the optical interface section 201 receives an optical transmission signal through the optical input line L_{IN2} and outputs a received signal to an overhead receiver (OH RCV) 202. The overhead receiver 202 extracts RSOH and MSOH from the received signal and outputs the RSOH and MSOH to both a DCC transmit byte extractor 203 and a DCC byte extractor 204. The DCC transmit byte extractor 203 extracts DCC transmit data from the DCC transmit bytes of the RSOH and MSOH to output it to an input port P_{IN3} of the cross connect 303. The DCC byte extractor 204 extracts DCC data from the DCC bytes of the RSOH and MSOH to output it to an input port P_{IN4} of the cross connect 303 and the DCC byte processor 301.

The DCC byte processor 301 produces a control packet from the DCC data received from the DCC byte extractor 104 or the DCC byte extractor 204 and provides routing processing to the control packet according to the communication protocol. In the case of TCP/IP protocol, the routing processing is performed by looking at IP address of the control packet. DCC data for the routing-processed control packet is output to one input of a corresponding one of selectors 105 and 205.

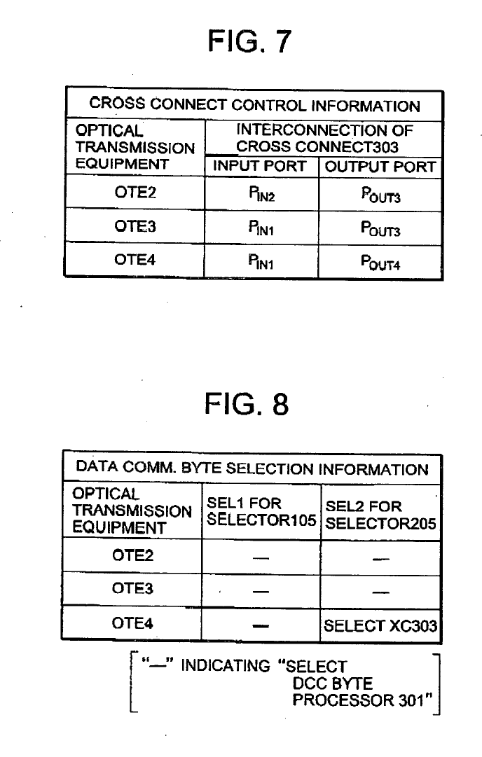

The cross connect 303 connects the input ports P_{IN1}-P_{IN4} to appropriate ones of output ports P_{OUT1}-P_{OUT4} depending on control information CTRL received from a processor 302. An example of the control information CTRL will be described later (see FIG. 7). The output port P_{OUT1} is connected to a DCC transmit byte inserter 106, the output port P_{OUT2} is connected to the other input of the selector 105, the output port P_{OUT3} is connected to a DCC transmit byte inserter 206, and the output port P_{OUT4} is connected to the other input of the selector 205.

The respective selectors 105 and 205 are independently controlled by selection signals SEL1 and SEL2 received from the processor 302. An example of the selection signals SEL1 and SEL2 will be described later (see FIG. 8). The selector 105 selects One of DCC data received from the output port P_{OUT2} and DCC data received from the DCC byte processor 301, and outputs a selected one to the DCC byte inserter 107. Similarly, the selector 205 selects one of DCC data received from the output port P_{OUT4} and DCC data received from the DCC byte processor 301, and outputs a selected one to the DCC byte inserter 207.

The DCC transmit byte inserter 106 receives DCC transmit data from the output port P_{OUT1} of the cross connect 303 and inserts it into the DCC transmit bytes of RSOH or MSOH to output to an overhead generator 105. The DCC byte inserter 107 receives DCC data from the selector 105 and inserts it into the DCC bytes of RSOH or MSOH to output to the overhead generator 108.

Similarly, the DCC transmit byte inserter 206 receives DCC transmit data from the output port P_{OUT3} of the cross connect 303 and inserts it into the DCC transmit bytes of RSOH or MSOH to output to an overhead generator 208. The DCC byte inserter 207 receives DCC data from the selector 205 and inserts it into the DCC bytes of RSOH or MSOH to output to the overhead generator 208.

The overhead generator 108 generates a section overhead to be transmitted from the RSOH and MSOH received from the DCC transmit byte inserter 106 and the DCC byte inserter 107. The section overhead to be transmitted and the payload (not shown) are transmitted through the optical interface 109 as an optical transmission signal to the optical output line L_{OUT1}.

Similarly, the overhead generator 208 generates a section overhead to be transmitted from the RSOH and MSOH received from the DCC transmit byte inserter 206 and the DCC byte inserter 207. The section overhead to be transmitted and the payload (not shown) are transmitted through the optical interface 209 as an optical transmission signal to the optical output line L_{OUT2}.

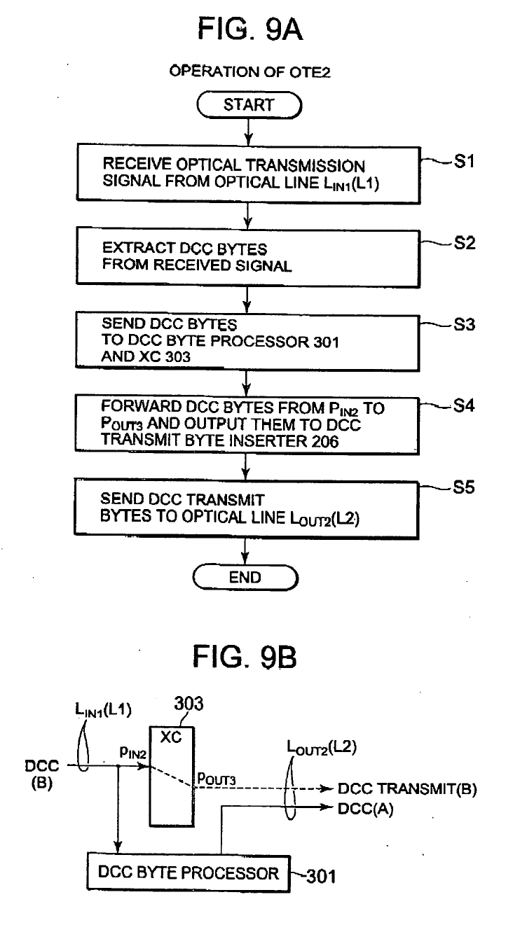

As described above, the processor 302 may be a program-controlled processor such as a CPU (Central Processing Unit) that controls interconnection of the cross connect 303 and selection of the selectors 105 and 205 by running control programs with user's setting data, which are previously stored in a memory 304. The control programs include one of operation control programs shown in FIGS. 9A, 10A and 11A. The user's setting data determines the cross connect control information CTRL and the selection information SEL1 and SEL2, as shown in FIGS. 7 and 8.

### 3. Data Transfer Operation

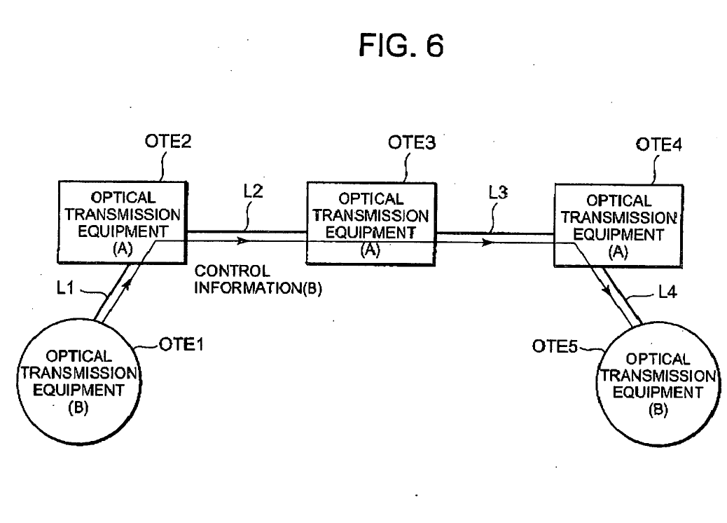

An operation of the above-described optical transmission equipment of FIG. 5 will be described in detail, taking as an example an optical transmission network as shown in FIG. 6.

Referring to FIG. 6, it is assumed that the optical transmission network is composed of optical transmission equipments OTE1-OTE5, which are connected in series such that the optical transmission equipments OTE1 and OTE2 are connected by an optical line L1, the optical transmission equipments OTE2 and OTE3 by an optical line L2, the optical transmission equipments OTE3 and OTE4 by an optical line L3, and the optical transmission equipments OTE4 and OTE5 by an optical line L4.

The optical transmission equipments OTE2-OTE4 work in a communication protocol A (e.g. TCP/IP) and the optical transmission equipments OTE1 and OTE5 work in a different communication protocol B (e.g. OSI). Accordingly, the optical transmission equipment OTE2 is connected to the optical transmission equipment OTE1 working in the different communication protocol B and to the optical transmission equipment OTE3 working in the same communication protocol A. The optical transmission equipment OTE3 is connected to the optical transmission equipment OTE2 working in the same communication protocol A and also to the optical transmission equipment OTE4 working in the same communication protocol A. The optical transmission equipment OTE4 is connected to the optical transmission equipment OTE3 working in the same communication protocol A and to the optical transmission equipment OTE5 working in the different communication protocol B. In this example, the optical transmission equipments OTE2-OTE4 are provided according to the first embodiment as shown in FIG. 5.

In such a network, when control information (B) is transferred from the optical transmission equipment OTE1 to the optical transmission equipment OTE5, the operation of each of the optical transmission equipments OTE2-OTE4 will be described hereinafter.

3.1) Cross Connect Control Information CTRL

It is assumed that the cross connect control information for each optical transmission equipment has been set as shown in FIG. 7.

More specifically, in the optical transmission equipment OTE2, the processor 302 generates the cross connect control information CTRL based on the user's setting data to output it to the cross connect 303, which is set thereby to an interconnection state such that the input port P_{IN2} is connected to the output port P_{OUT3}.

Similarly, in the optical transmission equipment OTE3, the cross connect 303 is set to an interconnection state such that the input port P_{IN1} is connected to the output port P_{OUT3}. In the optical transmission equipment OTE4, the cross connect 303 is set to an interconnection state such that the input port P_{IN1} is connected to the output port P_{OUT4}.

3.2) Selection Information SEL1 and SEL2

As shown in FIG. 8, in the optical transmission equipment OTE2, the processor 302 generates the selection information SEL1 and SEL2 based on the user's setting data to output them to the respective selectors 105 and 205, causing the selectors 105 and 205 to select DCC data inputted from the DCC byte processor 301. In the optical transmission equipment OTE3, the selectors 105 and 205 also select DCC data inputted from the DCC byte processor 301.

However, in the optical transmission equipment OTE4, the processor 302 outputs the selection information SEL1 and SEL2 to the respective selectors 105 and 205, causing the selector 105 to select DCC data inputted from the DCC byte processor 301 and the selector 205 to select DCC transmit data inputted from the output port P_{OUT4} of the cross connect 303.

3.3) Transmission Operation at OTE2

Referring to FIG. 9A, when having received an optical transmission signal through the optical input line L_{IN1} (here, L1) (step S1), the DCC byte extractor 104 extracts DCC bytes from the received signal (step S2) and Outputs the DCC bytes to the DCC byte processor 301 and the cross connect 303 (step S3).

Since the cross connect 303 connects the input port P_{IN2} to the output port P_{OUT3} as described above (see FIG. 9B), the DCC bytes are forwarded from the input port P_{IN2} to the output port P_{OUT3}, from which the DCC bytes are outputted to the DCC transmit byte inserter 206 (step S4). Accordingly the DCC transmit bytes are transmitted to the optical output line L_{OUT2} (here, L2) through the OH generator 208 and the optical interface section 209 (step S5).

On the other hand, since the selector 205 selects DCC data from the DCC byte processor 301, DCC bytes are also transmitted to the optical output line L_{OUT2} (here, L2) through the selector 205, the DCC byte inserter 207, the OH generator 208 and the optical interface section 209.

3.4) Transmission Operation at OTE3

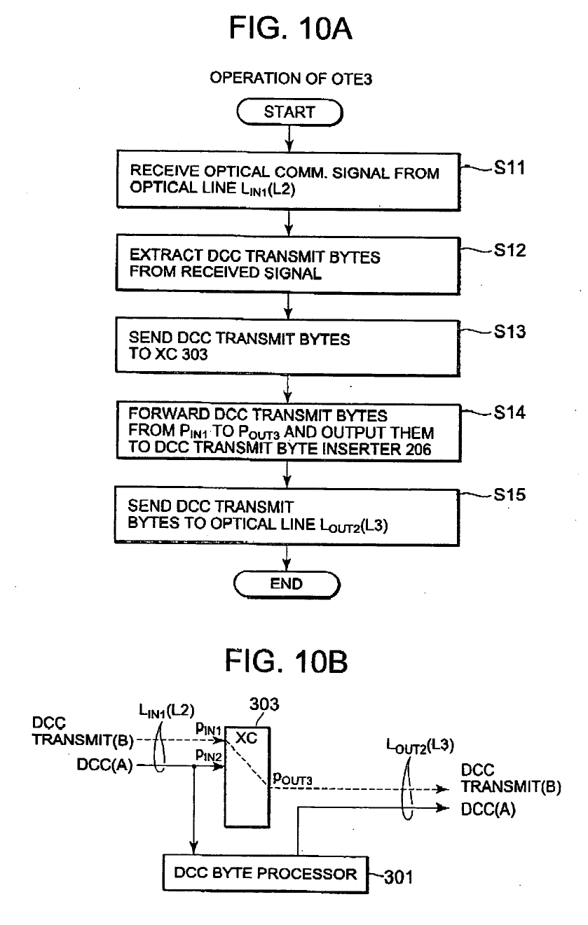

Referring to FIG. 10A, when having received an optical transmission signal from the OTE2 through the optical input line L_{IN1} (here, L2) (step S11), the DCC transmit byte extractor 103 extracts DCC transmit bytes from the received signal (step S12) and outputs the DCC transmit bytes to the cross connect 303 (step 313). Further, the DCC byte extractor 104 extracts DCC bytes from the received signal and outputs the DCC bytes to the DCC byte processor 301 and the cross connect 303.

Since the cross connect 303 connects the input port P_{IN1} to the output port P_{OUT3} as described above (see FIG. 10B), the DCC transmit bytes are forwarded from the input port P_{IN1} to the output port P_{OUT3}, from which the DCC transmit bytes are outputted to the DCC transmit byte inserter 206 (step S14). Accordingly the DCC transmit bytes are transmitted to the optical output line L_{OUT2} (here, L3) through the OH generator 208 and the optical interface section 209 (step S15).

On the other hand, since the selector 205 selects DCC data from the DCC byte processor 301, the routing-processed DCC bytes outputted from the DCC byte processor 301 to the selector 205 are also transmitted to the optical output line L_{OUT2} (here, L3) through the selector 205, the DCC byte inserter 207, the OH generator 208 and the optical interface section 209.

3.5) Transmission Operation at OTE4

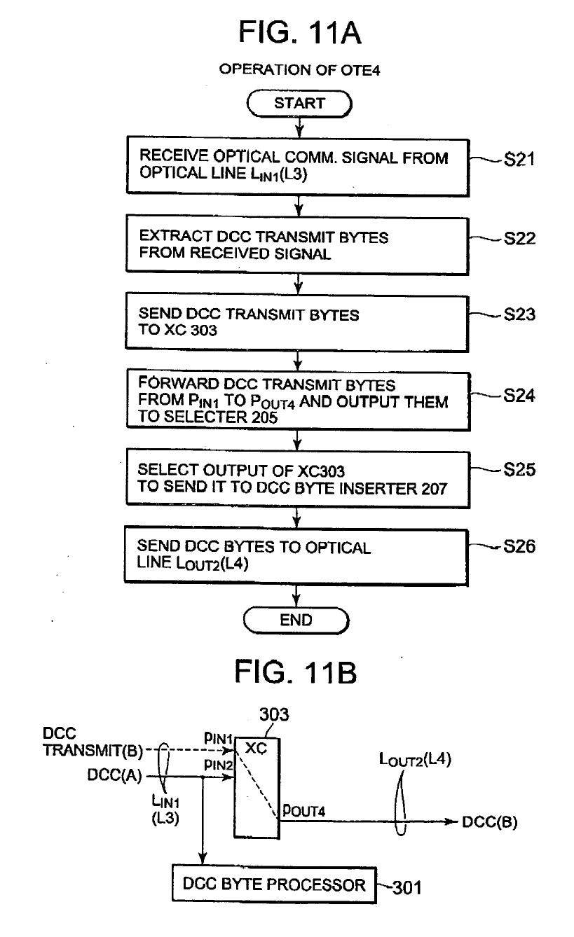

Referring to FIG. 11A, when having received an optical transmission signal from the OTE3 through the optical input line L_{IN1} (here, L3) (step S21), the DCC transmit byte extractor 103 extracts DCC transmit bytes from the received signal (step S22) and outputs the DCC transmit bytes to the cross connect 303 (step S23). Further, the DCC byte extractor 104 extracts DCC bytes from the received signal and outputs the DCC bytes to the DCC byte processor 301 and the cross connect 303.

Since the cross connect 303 connects the input port P_{IN1} to the output port P_{OUT4} as described above (see FIG. 11B), the DCC transmit bytes are forwarded from the input port P_{IN1} to the output port P_{OUT4}, from which the DCC transmit bytes are outputted to the DCC byte inserter 207 (step S24).

Since the selector 205 selects DCC data from the cross connect 303 as shown in FIG. 8 (step S25), the DCC transmit bytes appearing on the output port P_{OUT4} are transmitted as DCC bytes to the optical output line L_{OUT2} (here, L4) through the selector 205, the DCC byte inserter 207, the OH generator 208 and the optical interface section 209 (step S26).

As described above, according to the first embodiment of the present invention, the optical transmission equipments OTE2-OTE4 can transfer the control packet (B) without control by the communication protocol A. Accordingly, the control packet is transferred from the optical transmission equipment OTE1 to the optical transmission equipment OTE5 through the optical transmission equipments OTE2-OTE4. Since the optical transmission equipments OTE2-OTE4 do not provide control by the communication protocol A to the control packet (B), a control packet for any communication protocol can be transferred.

The optical transmission network as shown in FIG. 6 is just an example. The present invention can be applied to any network composed of a plurality of optical transmission equipments like the optical transmission equipment OTE3 provided between the optical transmission equipments OTE2 and OTE4.

### 4. Second Embodiment

The present invention can be also applied to any network composed of a plurality of optical transmission equipments working in the same communication protocol.

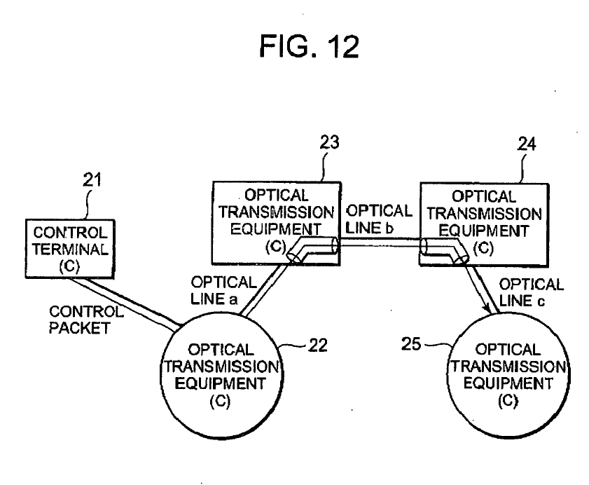

As shown in FIG. 12, for the sake of simplicity, it is assumed that a network is composed of a control terminal 21 and optical transmission equipments 22-25 working in the same communication protocol C. In such a network, the control terminal 21 can control the optical transmission equipments 22-25 by sending a control packet to each of the optical transmission equipments 22-25.

More specifically, when having received the control packet from the control terminal 21, at each optical transmission equipment, a DCC byte processor provides routing processing to the control packet according to the communication protocol C. Accordingly, if all the optical transmission equipments 22-25 are conventionally configured and the control terminal 21 sends a control packet targeted for the optical transmission equipment 25, then the number of hops the control packet needs to reach the targeted equipment is 3 in this example.

In contrast, if the present invention is applied to the optical transmission equipments 23 and 24 as shown in FIG. 5, then the control packet can be transferred to the next hop without routing processing based on the communication protocol C at each of the optical transmission equipments 23 and 24. More specifically, the respective optical transmission equipments 23 and 24 are configured like the optical transmission equipments OTE2 and OTE4 as shown in FIG. 6. Accordingly, when the control terminal 21 sends a control packet targeted for the optical transmission equipment 25, the number of hops the control packet needs to reach the targeted equipment is reduced to 1 in this example.

In this manner, in a network composed of a plurality of optical transmission equipments working in the same communication protocol, optical transmission equipments according to the present invention can transfer a control packet without routing processing, resulting in the reduced number of hops from the control terminal to a targeted equipment.

1. A data transfer system for transferring control information from a control terminal to a target through a data transmission network including at least one data transmission equipment working in a predetermined communication protocol, wherein
each of said at least one data transmission equipment comprises:
a receiving section for receiving a transmission signal including control information from upstream;
a transmitting section for transmitting a transmission signal including control information to downstream; and
a forwarding section for forwarding control information included in a received transmission signal to the transmitting section without controlling the control information according to the predetermined communication protocol.

2. The data transfer system according to claim 1, wherein the forwarding section comprises:
a data extractor for extracting the control information from the received transmission signal; and
a data inserter for inserting the extracted control information into a predetermined one of a first location and a second location of the transmission signal to be transmitted.

3. The data transfer system according to claim 2, wherein the first location is data communication channel (DCC) bytes of the transmission signal and the second location is DCC transmit bytes that are previously determined in the transmission signal.

4. The data transfer system according to claim 3, wherein
the data extractor extracts the control information from the first location of the received transmission signal; and
the data inserter inserts the extracted control information into the second location.

5. The data transfer system according to claim 3, wherein
the data extractor extracts the control information from the second location of the received transmission signal; and
the data inserter inserts the extracted control information into the second location.

6. The data transfer system according to claim 3, wherein
the data extractor extracts the control information from the second location of the received transmission signal; and
the data inserter inserts the extracted control information into the first location.

7. The data transfer system according to claim 1, wherein the forwarding section further comprises:
a data extractor for extracting the control information from the received transmission signal;
a first data inserter for inserting the extracted control information into a first location of the transmission signal to be transmitted;
a second data inserter for inserting the extracted control information into a second location of the transmission signal to be transmitted; and
a switch for forwarding the extracted control information to a selected one of the first and second data inserters depending on predetermined control information.

8. The data transfer system according to claim 4, wherein an upstream data transmission equipment works in a different communication protocol and a downstream data transmission equipment works in the predetermined communication protocol.

9. The data transfer system according to claim 5, wherein both an upstream data transmission equipment and a downstream data transmission equipment work in the predetermined communication protocol.

10. The data transfer system according to claim 6, wherein an upstream data transmission equipment works in the predetermined communication protocol and a downstream data transmission equipment works in a different communication protocol.

11. The data transfer system according to claim 1, wherein the data transmission network is composed of data transmission equipments working in the predetermined communication protocol.

12. The data transfer system according to claim 3, wherein bytes that are not used in the transmission signal are assigned to the DCC transmit bytes.

13. A data transmission apparatus in a data transfer system for transferring control information from a control terminal to a target through a data transmission network, wherein the data transmission apparatus works in a predetermined communication protocol, comprising:
a receiving section for receiving a transmission signal including control information from upstream;
a transmitting section for transmitting a transmission signal including control information to downstream; and
a forwarding section for forwarding control information included in a received transmission signal to the transmitting section without controlling the control information according to the predetermined communication protocol.

14. The data transmission apparatus according to claim 13, wherein the forwarding section comprises:
a data extractor for extracting the control information from the received transmission signal; and
a data inserter for inserting the extracted control information into a predetermined one of a first location and a second location of the transmission signal to be transmitted.

15. The data transmission apparatus according to claim 14, wherein the first location is data communication channel (DCC) bytes of the transmission signal and the second location is DCC transmit bytes that are previously determined in the transmission signal.

16. The data transmission apparatus according to claim 15, wherein
the data extractor extracts the control information from the first location of the received transmission signal; and
the data inserter inserts the extracted control information into the second location.

17. The data transmission apparatus according to claim 15, wherein
the data extractor extracts the control information from the second location of the received transmission signal; and
the data inserter inserts the extracted control information into the second location.

18. The data transmission apparatus according to claim 15, wherein
the data extractor extracts the control information from the second location of the received transmission signal; and
the data inserter inserts the extracted control information into the first location.

19. The data transmission apparatus according to claim 13, wherein the forwarding section further comprises:
a data extractor for extracting the control information from the received transmission signal;
a first data inserter for inserting the extracted control information into a first location of the transmission signal to be transmitted;
a second data inserter for inserting the extracted control information into a second location of the transmission signal to be transmitted; and
a switch for forwarding the extracted control information to a selected one of the first and second data inserters depending on predetermined control information.

20. A data transfer method for transferring control information from a control terminal to a target through a data transmission network including at least one data transmission equipment working in a predetermined communication protocol, comprising:
at each of said at least one data transmission equipment,
a) receiving a transmission signal including control information at a receiving section from upstream;
b) forwarding control information included in a received transmission signal to a transmitting section without controlling the control information according to the predetermined communication protocol; and
c) transmitting a transmission signal including the control information from the transmitting section to downstream.

21. The data transfer method according to claim 20, wherein the step b) comprises:
b.1) extracting the control information from the received transmission signal; and
b.2) inserting the extracted control information into a predetermined one of a first location and a second location of the transmission signal to be transmitted.

22. The data transfer method according to claim 21, wherein the first location is data communication channel (DCC) bytes of the transmission signal and the second location is DCC transmit bytes that are previously determined in the transmission signal.

23. The data transfer method according to claim 22, wherein
in the step b.1), the control information is extracted from the first location of the received transmission signal; and
in the step b.2), the extracted control information is inserted into the second location.

24. The data transfer method according to claim 22, wherein
in the step b.1), the control information is extracted from the second location of the received transmission signal; and
in the step b.2), the extracted control information is inserted into the second location.

25. The data transfer method according to claim 22, wherein
in the step b.1), the control information is extracted from the second location of the received transmission signal; and
in the step b.2), the extracted control information is inserted into the first location.

26. The data transfer method according to claim 22, wherein bytes that are not used in the transmission signal are assigned to the DCC transmit bytes.

27. A program instructing a computer of a data transmission equipment to forward control information, wherein the data transmission equipment works in a predetermined communication protocol, comprising the steps of:
a) receiving a transmission signal including control information at a receiving section from upstream;
b) forwarding control information included in a received transmission signal to a transmitting section without controlling the control information according to the predetermined communication protocol; and
c) transmitting a transmission signal including the control information from the transmitting section to downstream.

28. The program according to claim 27, wherein the step b) comprises:
b.1) extracting the control information from the received transmission signal; and
b.2) inserting the extracted control information into a predetermined one of a first location and a second location of the transmission signal to be transmitted.

29. The program according to claim 28, wherein the first location is data communication channel (DCC) bytes of the transmission signal and the second location is DCC transmit bytes that are previously determined in the transmission signal.
